(19) United States
(12) Patent Application Publication
(10) Pub. No.: US 2026/0023250 A1
(43) Pub. Date: Jan. 22, 2026

(54) OPTICAL SYSTEM AND IMAGE PICKUP APPARATUS

(71) Applicant: CANON KABUSHIKI KAISHA, Tokyo (JP)

(72) Inventor: Atsushi KUJI, Tochigi (JP)

(21) Appl. No.: 19/232,938

(22) Filed: Jun. 10, 2025

(30) Foreign Application Priority Data
Jul. 16, 2024 (JP) 2024-113273

(51) Int. Cl. G02B 17/08; G02B 5/30

(52) U.S. Cl. CPC G02B 17/0856; G02B 5/3083

(57) ABSTRACT

An optical system includes a first lens disposed closest to an object, a first transmissive reflective surface, a first waveplate, a second transmissive reflective surface, a second waveplate, and a third transmissive reflective surface arranged in this order from an object side to an image side, and an aperture stop. A predetermined inequality is satisfied.

### BACKGROUND

### Field of the Technology

The present disclosure relates to an optical system for an image pickup apparatus, such as a digital camera.

### Description of the Related Art

As such an optical system, a so-called folded optical system using a plurality of transmissive reflective surfaces have been proposed.

### SUMMARY

An optical system according to one aspect of the present disclosure includes a first lens disposed closest to an object, a first transmissive reflective surface, a first waveplate, a second transmissive reflective surface, a second waveplate, and a third transmissive reflective surface arranged in this order from an object side to an image side, and an aperture stop. The following inequality is satisfied:

$$- 0.20 < L 1 s / L < 0.95$$

where L is a distance on an optical axis from a surface on the object side of the first lens to the image plane, and L1s is a distance on the optical axis from the surface on the object side of the first lens to the aperture stop. An optical system another aspect of the disclosure includes first lens disposed closest to an object, a first transmissive reflective surface, a first waveplate, a second transmissive reflective surface, a second waveplate, and a third transmissive reflective surface, and an aperture stop. Light incident from the object side is imaged on an image plane via two optical paths including transmission and reflection at the first transmissive reflective surface, the second transmissive reflective surface, and the third transmissive reflective surface. An optical system according to another aspect of the present disclosure includes a first lens disposed closest to an object, a first transmissive reflective surface, a first waveplate, a second transmissive reflective surface, a second waveplate, and a third transmissive reflective surface arranged in this order from an object side to an image side, and an aperture stop. The first transmissive reflective surface is a convex surface toward the object side, and the third transmissive reflective surface is a concave surface toward the object side. The following inequality is satisfied:

$$- 0.20 < L 1 s / L < 0.95$$

where L is a distance on an optical axis from a surface on the object side of the first lens to the image plane, and L1s is a distance on the optical axis from the surface on the object side of the first lens to the aperture stop. An image pickup apparatus having one of the above optical systems also constitutes another aspect of the disclosure.

Further features of various embodiments of the disclosure will become apparent from the following description of embodiments with reference to the attached drawings. The following description of embodiments will be provided by way of example.

### BRIEF DESCRIPTION OF THE DRAWINGS

FIG. 1 illustrates optical paths in the optical system according to each example.

FIG. 2 illustrates a sectional view (first optical path) of the imaging optical system according to Example 1.

FIG. 3 illustrates a sectional view (second optical path) of the imaging optical system according to Example 1.

FIG. 4 illustrates a longitudinal aberration diagram of the imaging optical system according to Example 1 in an in-focus state at infinity.

FIG. 5 illustrates a longitudinal aberration diagram of the imaging optical system according to Example 1 in an in-focus state at a close distance.

FIG. 6 illustrates a sectional view (first optical path) of an imaging optical system according to Example 2.

FIG. 7 illustrates a sectional view (second optical path) of the imaging optical system according to Example 2.

FIG. 8 illustrates a longitudinal aberration diagram of the imaging optical system according to Example 2 in an in-focus state at infinity.

FIG. 9 illustrates a longitudinal aberration diagram of the imaging optical system according to Example 2 in an in-focus state at a close distance.

FIG. 10 illustrates a sectional view (first optical path) of an imaging optical system according to Example 3.

FIG. 11 illustrates a sectional view (second optical path) of the imaging optical system according to Example 3.

FIG. 12 illustrates a longitudinal aberration diagram of the imaging optical system according to Example 3 in an in-focus state at infinity.

FIG. 13 illustrates a longitudinal aberration diagram of the imaging optical system

according to Example 3 in an in-focus state at a close distance.

FIG. 14 illustrates a sectional view (first optical path) of an imaging optical system according to Example 4.

FIG. 15 illustrates a sectional view (second optical path) of the imaging optical system according to Example 4.

FIG. 16 illustrates a longitudinal aberration diagram of the imaging optical system according to Example 4 in an in-focus state at infinity.

FIG. 17 illustrates a longitudinal aberration diagram of the imaging optical system according to Example 4 in an in-focus state at a close distance.

FIG. 18 illustrates a sectional view (first optical path) of an imaging optical system according to Example 5.

FIG. 19 illustrates a sectional view (second optical path) of the imaging optical system according to Example 5.

FIG. 20 illustrates a longitudinal aberration of the imaging optical system according to Example 5 in an in-focus state at infinity.

FIG. 21 illustrates a longitudinal aberration of the imaging optical system according to Example 5 in an in-focus state at a close distance.

FIG. 22 illustrates a sectional view (first optical path) of an imaging optical system

according to Example 6.

FIG. 23 illustrates a sectional view (second optical path) of the imaging optical system according to Example 6.

FIG. 24 illustrates a longitudinal aberration of the imaging optical system according to Example 6 in an in-focus state at infinity.

FIG. 25 illustrates a diagram of the longitudinal aberration of the imaging optical system according to Example 6 in an in-focus state at a close distance.

FIG. 26 illustrates an image pickup apparatus using the imaging optical system according to any one of Examples 1 to 6.

### DESCRIPTION OF THE EMBODIMENTS

Referring now to the accompanying drawings, a detailed description will be given of embodiments according to the disclosure. First, common matters to Examples 1 to 6 will be described.

An imaging optical system (simply referred to as an optical system hereinafter) according to each example images light from an object on an image plane. A solid-state image sensor such as a CCD sensor or a CMOS sensor or a photosensitive film such as a silver film is disposed on the image plane, and an image is obtained by capturing an object image.

The optical system according to each example includes, in order from the object side to the image side, a first lens closest to the object, and a first transmissive reflective surface (HM1), a first waveplate (QWP1), a second transmissive reflective surface (HM2), a second waveplate (QWP2), and a third transmissive reflective surface (HM3). The first and second waveplates are, for example, quarter waveplates. The optical system configured in this way guides light incident from the object side to the image plane (IM) via the following two optical paths. The optical system according to each example further includes an aperture stop (STO).

### First Optical Path

Light from the object side transmits through the first transmissive reflective surface, the first waveplate, the second transmissive reflective surface, and the second waveplate in this order, is reflected by the third transmissive reflective surface toward the object side, transmits through the second waveplate, is reflected by the second transmissive reflective surface toward the image side, transmits through the second waveplate and the third transmissive reflective surface, and reaches the image plane.

### Second Optical Path

The light from the object side transmits through the first transmissive reflective surface and the first waveplate in this order, is reflected by the second transmissive reflective surface toward the object side, transmits through the first waveplate, is reflected by the first transmissive reflective surface toward the image side, transmits through the first waveplate, the second transmissive reflective surface, the second waveplate, and the third transmissive reflective surface, and reaches the image plane.

These two optical paths are configured so that the focal length and back focus (the air-equivalent distance on the optical axis from a lens surface closest to the image plane of the optical system to the image plane) are the same. The term “same,” as used herein, means same in terms of design, and is considered to be same even if there is a difference within the manufacturing tolerance range in the actual optical system (such as a difference of 5%, 2%, or 1%). Thereby, the light beams passing through the two optical paths can be superimposed on the image plane, achieving an effect equivalent to doubling the transmittance of the optical system, in other words, an object image that is twice as bright. A ratio of the transmittance to the reflectance of each of the first to third

transmissive reflective surfaces may be 50%: 50% (1:1), or may be any other ratio. More specifically, a ratio of the transmittance to the reflectance for randomly polarized light may be in the range of 1:3 to 3:1. Randomly polarized light is light with Stokes parameters S0=1, S1=S2=S3=0. The first transmissive reflective surface, the second transmissive reflective surface, and the third transmissive reflective surface may have a light absorbing effect. Lenses may be formed or cemented to both or one side of each transmissive reflective surface.

For example, a polymer film or liquid crystal alignment layer having birefringence may be used as the first and second waveplates. A laminate of such polymer films or liquid crystal alignment layers may also be used. Properly laminating can provide a phase difference close to a quarter of the wavelength over a wide wavelength range. For example, “WA-140T” by Nippon Kayaku Co., Ltd. or “Polar Correct” by Colorlink Japan Co., Ltd. may be used. In addition to the above products, inorganic waveplates by Dexerials Corporation may also be used as the first and second waveplates.

Each of the first and second waveplates can be disposed by bonding them to one of the transmissive reflective surfaces. They may also be disposed as separate members from the transmissive reflective surfaces. For example, they may be disposed as films in the optical path, or the film may be bonded to a glass plate and placed in the optical path. A lens may be formed or cemented on one or both sides of each waveplate. For example, a lens may be formed on one or both sides of the inorganic waveplate using wafer-level optics technology with the inorganic waveplate as a substrate.

The above configuration can provide an optical system having a reduced size and a bright F-number.

The optical system according to each example may satisfy at least one of the following inequalities.

The imaging optical system according to each example may satisfy the following inequality (1):

$$- 0.20 < L 1 s / L < 0.95 \qquad ( 1 )$$

where L is a distance (overall length) from a surface on the object side (front surface) of the first lens closest to the object in the optical system to the image plane, and L1s is a distance on the optical axis from the foremost surface to the aperture stop.

In a case where L1s reduces in the negative direction so that L1s/L becomes lower than the lower limit of inequality (1), the height of an off-axis light ray increases, and it becomes difficult to correct aberrations such as curvature of field. In a case where L1s increases so that L1s/L becomes higher than the upper limit of inequality (1), it becomes difficult to secure the back focus.

The lower limit of inequality (1) may be set to −0.18, −0.16, −0.15, −0.14, −0.12, or −0.11. The upper limit of inequality (1) may be set to 0.90, 0.85, 0.80, 0.75, or 0.70.

The above configuration can provide an optical system that has a bright F-number, a reduced size, and has high optical performance.

Next follows a description of inequalities that may be satisfied by the optical system according to each example.

The optical system according to each example may satisfy the following inequality (2):

$$1.05 < Nd < 2.50 \qquad ( 2 )$$

where Nd is a minimum refractive index for the d-line (with a wavelength of 587.6 nm) of a medium (lens, etc.) between the first transmissive reflective surface and the second transmissive reflective surface and a medium between the second transmissive reflective surface and the third transmissive reflective surface.

In a case where Nd becomes lower than the lower limit of inequality (2), an additional lens is required to correct the Petzval term that occurs during reflection, and the size of the optical system increases. In a case where Nd becomes higher than the upper limit of inequality (2), it becomes difficult to correct chromatic aberration that occurs during refraction because high refractive index materials generally have high dispersion.

The lower limit of inequality (2) may be set to 1.10, 1.15, 1.20, 1.25, 1.30, 1.35, or 1.40. The upper limit of inequality (2) may be set to 2.40, 2.30, 2.20, 2.10, 2.00, or 1.90.

The optical system according to each example may satisfy the following inequality (3):

$$0. 20 < Zm 3 / f < 2.00 \qquad ( 3 )$$

where Zm3 is a distance on the optical axis from the third transmissive reflective surface to the image plane, and f is a focal length of the optical system.

In a case where Zm3 reduces so that Zm3/f becomes lower than the lower limit of inequality (3), it becomes difficult to secure the back focus. In a case where Zm3 increases so that Zm3/f becomes higher than the upper limit of inequality (3), the size of the optical system increases, and in particular, correction of curvature of field becomes difficult.

The lower limit of inequality (3) may be set to 0.15, 0.20, 0.25, 0.30, 0.35, or 0.40, and the upper limit of inequality (3) may be set to 1.90, 1.80, 1.70, 1.60, 1.50, or 1.40.

The optical system according to each example may satisfy the following inequality (4):

$$0.01 < Dm 12 / L < 0.2 \qquad ( 4 )$$

where Dm12 is a distance on the optical axis between the first transmissive reflective surface and the second transmissive reflective surface.

In a case where Dm12 reduces so that Dm12/L becomes lower than the lower limit of inequality (4), the first and second transmissive reflective surfaces may interfere with each other. In a case where Dm12 increases so that Dm12/L becomes higher than the upper limit of inequality (4), it becomes difficult to correct, in particular, coma.

The upper limit of inequality (4) may be set to 0.19, 0.18, 0.17, 0.16, or 0.15.

The optical system according to each example may satisfy the following inequality (5):

$$0.5 < f 1 s / f < 7.00 \qquad ( 5 )$$

where f1s is a combined focal length of at least one lens (lens unit) disposed on the object side of the aperture stop.

In a case where f1s reduces so that f1s/f becomes lower than the lower limit of inequality (5), the combined power of the optical system up to the aperture stop increases, and especially spherical aberration and coma increase. In a case where f1s increases so that f1s/f becomes higher than the upper limit of inequality (5), the size of a part of the optical system disposed on the image side of the aperture stop increases.

The lower limit of inequality (5) may be set to 0.60, 0.70, 0.80, 0.90, 1.00, or 1.20. The upper limit of inequality (5) may be set to 6.80, 6.60, 6.50, 6.40, 6.20, 6.00, or 5.80.

The optical system according to each example may satisfy the following inequality (6):

$$0.5 < Φ3 / Φ < 2.00 \qquad ( 6 )$$

where Φ is optical power of the optical system, and Φ3 is optical power for the light reflected on the third transmissive reflective surface and calculated as follows:

$$Φ3 = - 2 \times Nd 3 / R$$

where Nd3 is a refractive index for the d-line of the medium disposed adjacent to and on the object side of the third transmissive reflective surface, and R is a radius of curvature of the third transmissive reflective surface. Φ is a reciprocal of the focal length of the optical system.

In a case where Φ3 reduces so that Φ3/Φ becomes lower than the lower limit of inequality (6), it becomes necessary to add and place a lens with large power, and the size of the optical system increases. In a case where Φ3 increases so that ϕ3/Φ becomes higher than the upper limit of inequality (6), the curvature of the third transmissive reflective surface increases, the decentering sensitivity, especially of coma increases.

The lower limit of inequality (6) may be set to 0.55, 0.60, 0.65, or 0.70. The upper limit of inequality (6) may be set to 1.90, 1.80, 1.70, 1.60, or 1.50.

The optical system according to each example may satisfy the following inequality (7):

$$1. < L / f < 5.5 \qquad ( 7 )$$

In a case where the distance L reduces so that L/f becomes lower than the lower limit of inequality (7), it becomes difficult to correct spherical aberration in particular. In a case where the distance L increases so that L/f becomes higher than the upper limit of inequality (7), the size of the optical system increases.

The lower limit of inequality (7) may be set to 1.10, 1.20, 1.30, 1.35, or 1.40. The upper limit of inequality (7) may be set to 5.25, 5.00, 4.75, or 4.50.

The optical system according to each example may satisfy the following inequality (8):

$$0.55 \leq Fno \leq 8. \qquad ( 8 )$$

where Fno is a maximum aperture value of the optical system.

In a case where Fno becomes lower than the lower limit of inequality (7), it becomes difficult to correct spherical aberration and coma in particular. In a case where Fno becomes higher than the upper limit of inequality (8), a light amount reaching the image plane reduces in addition to the light loss at each transmissive reflective surface.

The lower limit of inequality (8) may be set to 0.60, 0.70, 0.80 or 0.90. The upper limit of inequality (8) may be set to 7.00, 6.00, 5.00, 4.50, 4.00 or 3.00.

The optical system according to each example may have at least one of the following configurations.

The second transmissive reflective surface may be flat. In a case where the second transmissive reflective surface has a curvature, it becomes difficult to make the focal lengths of the two optical paths in the optical system identical to each other and the back focuses of the two optical paths in the optical system identical to each other.

The first transmissive reflective surface may be a convex surface toward the object side, and the third transmissive reflective surface may be a concave surface toward the object side. This configuration can make the power during reflection positive and reduce the size of the optical system.

The absolute values of the curvatures on the optical axis of the first transmissive reflective surface and the third transmissive reflective surface may be the same. The term “same,” as used herein, means as described above. This configuration can make the focal lengths of the two optical paths in the optical system identical to each other and back focuses of the two optical paths in the optical system identical to each other.

The first transmissive reflective surface and the third transmissive reflective surface may include a polarization-selective transmissive element. This configuration can reduce ghost light (unwanted light) in using a configuration utilizing polarization, which will be described later, and increase a light amount guided to the image plane via the two normal optical paths.

The third transmissive reflective surface may be disposed on the image side of the aperture stop. Due to this configuration, the light that has transmitted through the aperture stop is reflected (folded back) by the transmissive reflective surface, and the height of an off-axis ray can be increased and an incident angle on an image plane can be gentler. As a result, an optical system with a bright F-number can be achieved.

### Configuration Utilizing Polarization

Referring now to FIG. 1, a description will be given of the configuration utilizing polarization. A transmissive reflective surface disposed on the object side of the optical system is a polarization-selective transmissive reflective element (PBS1/HM1) A as a reflective polarizer, a transmissive reflective surface disposed on the image side is a polarization-selective transmissive reflective element (PBS2/HM3) E, and a transmissive reflective surface disposed between these two transmissive reflective surfaces is a half-mirror (HM2) C. A first quarter waveplate (QWP1) B serving as a first waveplate is disposed between the polarization-selective transmissive reflective element A and the half-mirror C, and a second quarter waveplate (QWP2) D serving as a second waveplate is disposed between the half-mirror C and the polarization-selective transmissive reflective element E.

The polarization-selective transmissive reflective element A is an element configured to transmit a first linearly polarized light and reflect a second linearly polarized light orthogonal to the first linearly polarized light. The polarization-selective transmissive reflective element E is an element configured to transmit the second linearly polarized light and reflect the first linearly polarized light. In other words, the polarization-selective transmissive reflective elements A and E are disposed so that their polarization transmission axes are orthogonal to each other.

The polarization-selective transmissive reflective element is, for example, a wire grid polarizer or a reflective polarizer having a laminated retardation film structure. At this time, the wire grid forming surface or retardation film surface of the polarization-selective transmissive reflective elements A and E function as a transmissive reflective surface.

The wire grid polarizer does not necessarily have to be made of aligned metal wires, but may have thin metal or dielectric layers at a predetermined interval and function as a polarization-selective transmission reflection element. For example, an element in which metal or dielectric layers are aligned by vapor deposition can be used.

The first quarter waveplate B and the second quarter waveplate D are disposed with their slow axes tilted by 45° relative to the polarization transmission axes of the polarization-selective transmission reflection elements A and E. The first quarter waveplate B and the second quarter waveplate D are disposed with their slow axes tilted by 90° relative to each other. Due to this arrangement, when light transmits through the first quarter waveplate B and the second quarter waveplate D, the wavelength dispersion characteristics of these waveplates B and D are offset.

The half-mirror C is, for example, a half-mirror formed by a dielectric multilayer film or metal vapor deposition, and functions as a transmissive reflective surface.

### Utilization of Polarization in First Optical Path

Light from the object side entering the optical system is converted into linearly polarized light by the polarization-selective transmissive reflective element A, which is then converted into circularly polarized light by the first quarter waveplate B and enters the half-mirror C. The circularly polarized light that enters the half-mirror C and transmits through it is converted into linearly polarized light in the same polarization direction as that when it passed through the polarization-selective transmissive reflective element A by the second quarter waveplate D and is reflected by the polarization-selective transmissive reflective element E. The reflected linearly polarized light is converted again into circularly polarized light by the second quarter waveplate D and enters the half-mirror C. A part of the circularly polarized light that entered the half-mirror C is reflected and converted into circularly polarized in the opposite direction, and returns to the second quarter waveplate D. The circularly polarized light that returns to the second quarter waveplate D is converted into linearly polarized light in a polarization direction orthogonal to that when it first passed through the polarization-selective transmissive reflective element A, by the second quarter waveplate D and enters the polarization-selective transmissive reflective element E. At this time, the polarization direction of the linearly polarized light coincides with the transmission axis of the polarization-selective transmissive reflective element E, so the linearly polarized light that enters the polarization-selective transmissive reflective element E transmits through it and is guided to the imaging plane IM.

### Utilization of Polarization in Second Optical Path

Light from the object side entering the optical system is converted into linearly polarized light by the polarization-selective transmissive reflective element A, which is then converted into circularly polarized light by the first quarter waveplate B and enters the half-mirror C. Up to this point, the process is the same as that in the first optical path.

Of the circularly polarized light that enters the half-mirror C, the circularly polarized light reflected by it is converted by the first quarter waveplate B into linearly polarized light that is orthogonal to the light that first passed through the polarization-selective transmissive reflective element A, and is reflected by the polarization-selective transmissive reflective element A. The linearly polarized light reflected by the polarization-selective transmissive reflective element A is converted again into circularly polarized light by the first quarter waveplate B and enters the half-mirror C. A part of the circularly polarized light incident on the half-mirror C transmits through the second quarter waveplate D, which converts it into linearly polarized light having the same polarization direction as the linearly polarized light reflected by the polarization-selective transmissive reflective element A. The linearly polarized light from the second quarter waveplate D is incident on the polarization-selective transmissive reflective element E. Since the polarization direction of the linearly polarized light at this time coincides with the transmission axis of the polarization-selective transmissive reflective element E, the linearly polarized light that has enters the polarization-selective transmissive reflective element E transmits through it and is guided to the image plane IM.

As described above, the light incident from the object side is guided to the image plane IM via these two optical paths. As a result, a small optical system with a bright F-number can be provided.

The terms “orthogonal (90°)”, “45°”, and “same” do not mean 90°, 45°, and same in the strict sense, and allows a difference of within ±5° (or within ±2°, or even within) ±1°).

In the optical system according to each example, the lens material may be a polymer material or a glass material. However, the lens disposed between the first transmissive reflective surface and the second transmissive reflective surface and the lens arranged between the second transmissive reflective surface and the third transmissive reflective surface may be made of a material with low birefringence.

Next follows a specific description of the optical systems according to Examples 1 to 6. After Example 6, numerical examples 1 to 6 corresponding to Examples 1 to 6 will be illustrated.

### Example 1

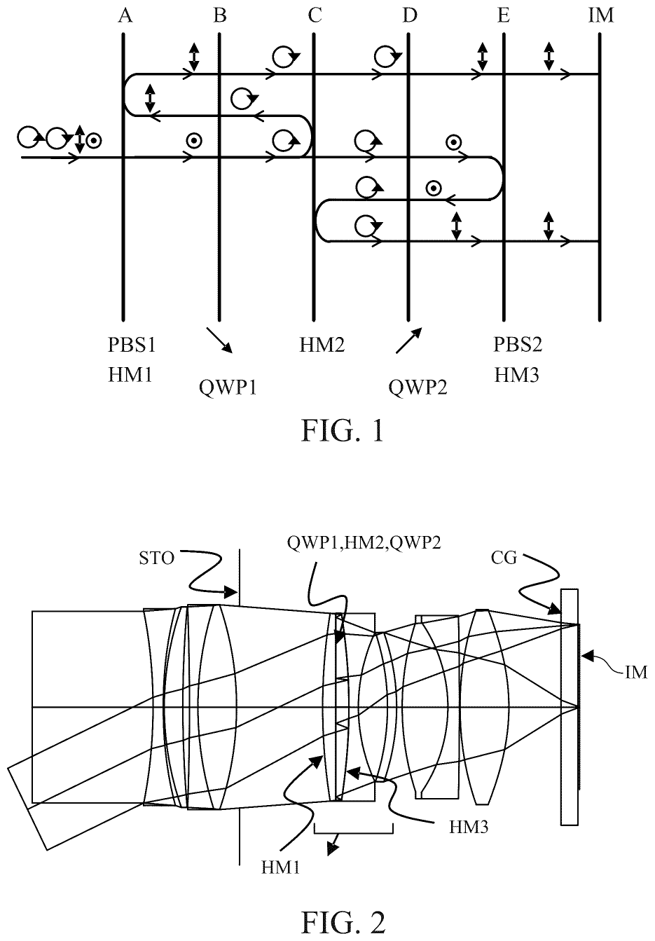

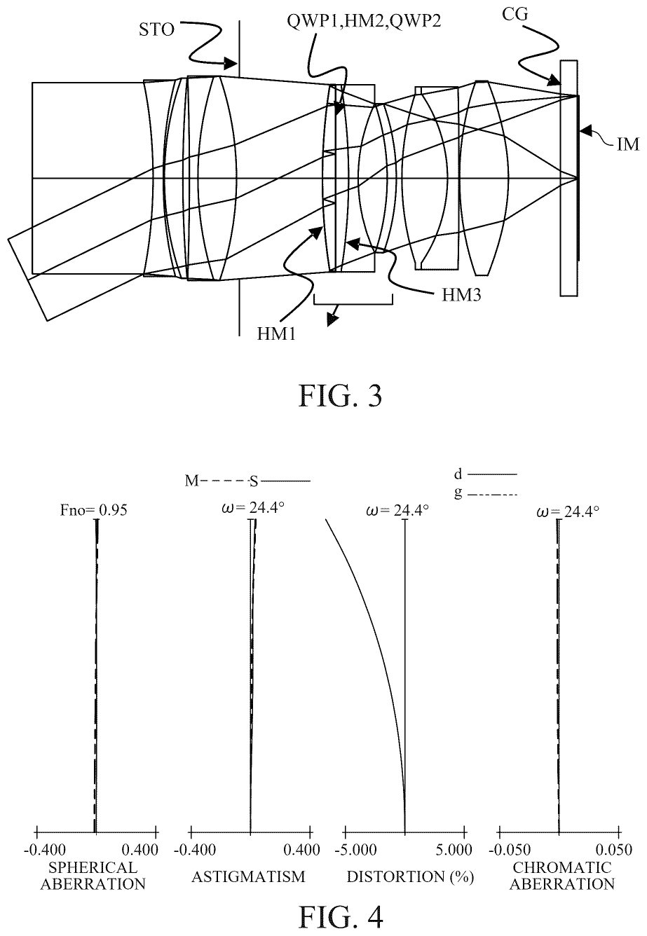

FIGS. 2 and 3 respectively illustrate sections of the first and second optical paths in an optical system according to Example 1 (numerical example 1). The optical system according to Example 1 includes, in order from the object side to the image side, an aperture stop STO, a first transmissive reflective surface HM1, a first waveplate QWP1, a second transmissive reflective surface HM2, a second waveplate QWP2, and a third transmissive reflective surface HM3. The optical system according to this example further includes a plurality of lenses including a first lens.

The first transmissive reflective surface HM1 is provided on a convex surface on the object side of a lens disposed on the image side of the aperture stop STO, and the third transmissive reflective surface HM3 is provided on a concave surface on the object side of a lens closer to the image plane. The first waveplate QWP1, the second transmissive reflective surface HM2, and the second waveplate QWP2 are provided on a flat surface on the image side of the lens on which the first transmissive reflective surface HM1 is provided.

An image sensor is provided on the image plane IM, and a sensor protective glass CG is provided on the display surface side of the image sensor.

The optical system according to numerical example 1 has an aperture ratio of about 0.95 and a half angle of view of about 24.38°.

In this optical system, focusing can be performed by moving a part of the lenses in the optical axis direction. A moving direction of the lens to be moved during focusing from infinity to a close distance is indicated by an arrow in the figures. This is similarly applicable to other examples described later.

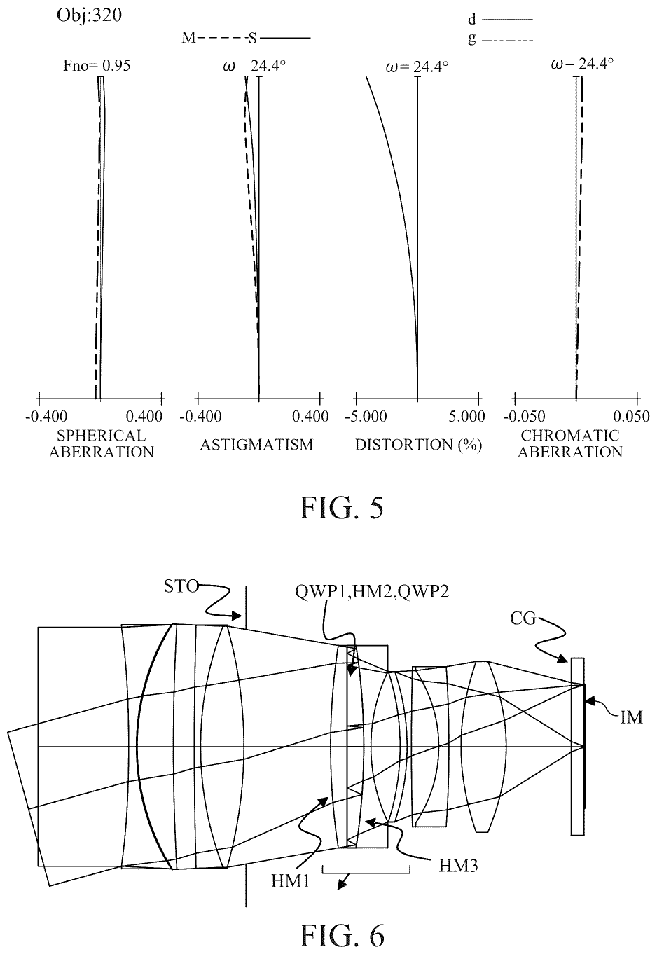

FIG. 4 illustrates a longitudinal aberration (spherical aberration, astigmatism, distortion, and chromatic aberration) of the optical system according to numerical example 1 in an in-focus state on an object at infinity (referred to as “in an in-focus state at infinity” hereinafter). FIG. 5 illustrates a longitudinal aberration of the optical system according to numerical example 1 in an in-focus state on an object at a close distance (referred to as “in an in-focus state at a close distance” hereinafter). The value of obj in FIG. 5 is a distance (mm) from the object plane to the in-focus plane (image plane).

In the spherical aberration diagram, Fno represents an F-number. A solid line indicates a spherical aberration amount for the d-line (with a wavelength of 587.6 nm), and an alternate long and two short dashes line indicates a spherical aberration amount for the g-line (with a wavelength of 435.8 nm). In the astigmatism diagram, a solid line S indicates an astigmatism amount on a sagittal image plane, and a broken line M indicates an astigmatism amount on a meridional image plane. The distortion diagram illustrates a distortion amount for the d-line. The chromatic aberration diagram illustrates a lateral chromatic aberration amount for the g-line. ω represents a half angle of view) (°). The description of the above aberration diagrams is similarly applicable to the other examples described below.

### Example 2

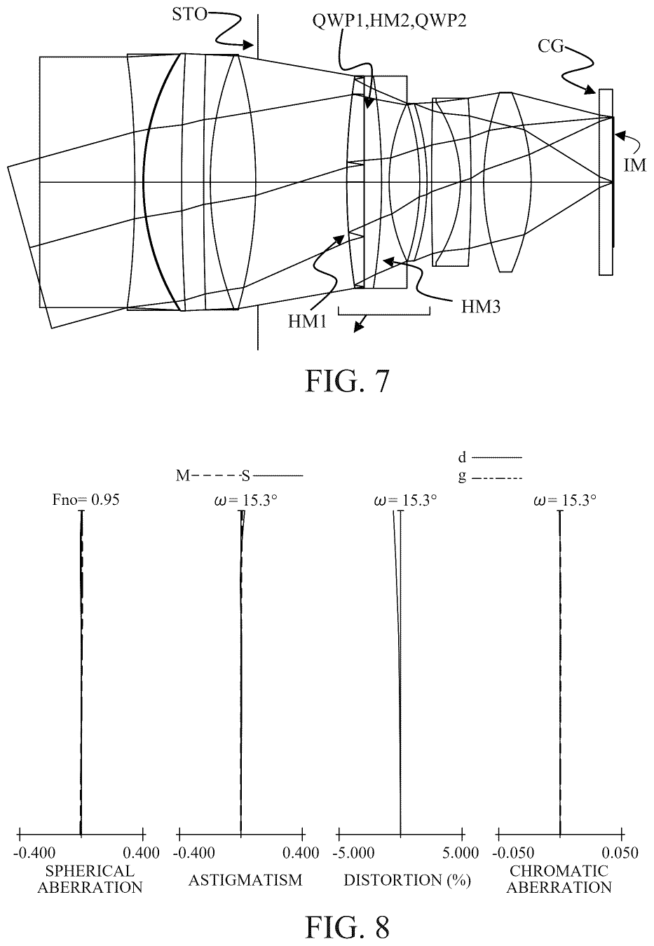

FIGS. 6 and 7 respectively illustrate sections of the first and second optical paths in an optical system according to Example 2 (numerical example 2). The basic configuration of the optical system according to this example is similar to that of Example 1.

In this example, the first transmissive reflective surface HM1 is provided on a convex surface on the object side of a lens disposed on the image side of the aperture stop STO, and the third transmissive reflective surface HM3 is provided on a concave surface on the object side of a lens closer on the image plane. The first waveplate QWP1, the second transmissive reflective surface HM2, and the second waveplate QWP2 are provided on the flat surface on the image side of the lens on which the first transmissive reflective surface HM1 is provided.

The optical system according to numerical example 2 is an optical system with an aperture ratio of approximately 0.95 and a half angle of view of approximately 15.27°.

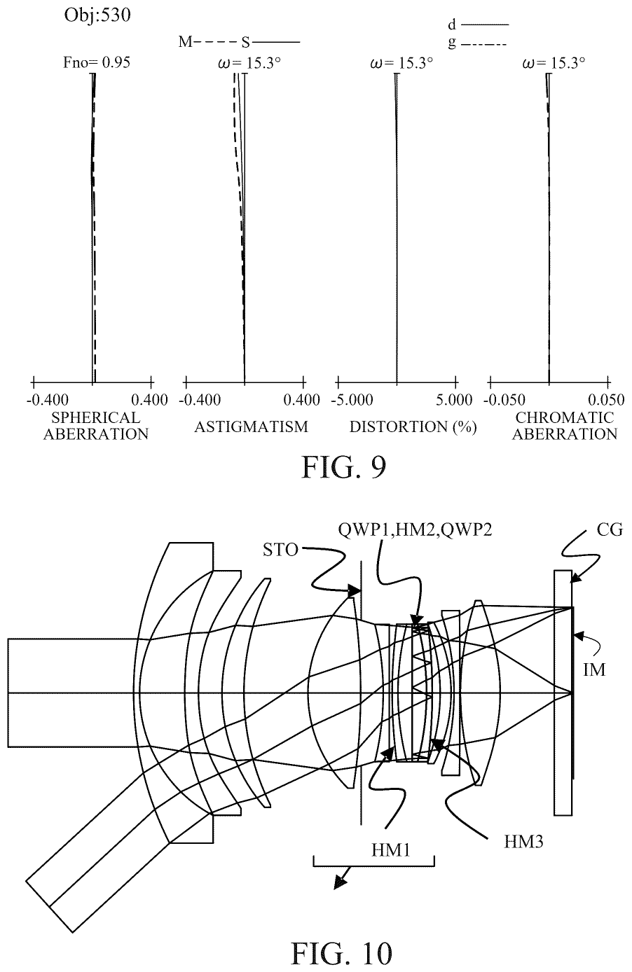

FIGS. 8 and 9 illustrate longitudinal aberrations of the optical system according to numerical example 2 in an in-focus state at infinity and in an in-focus state at a close distance, respectively.

### Example 3

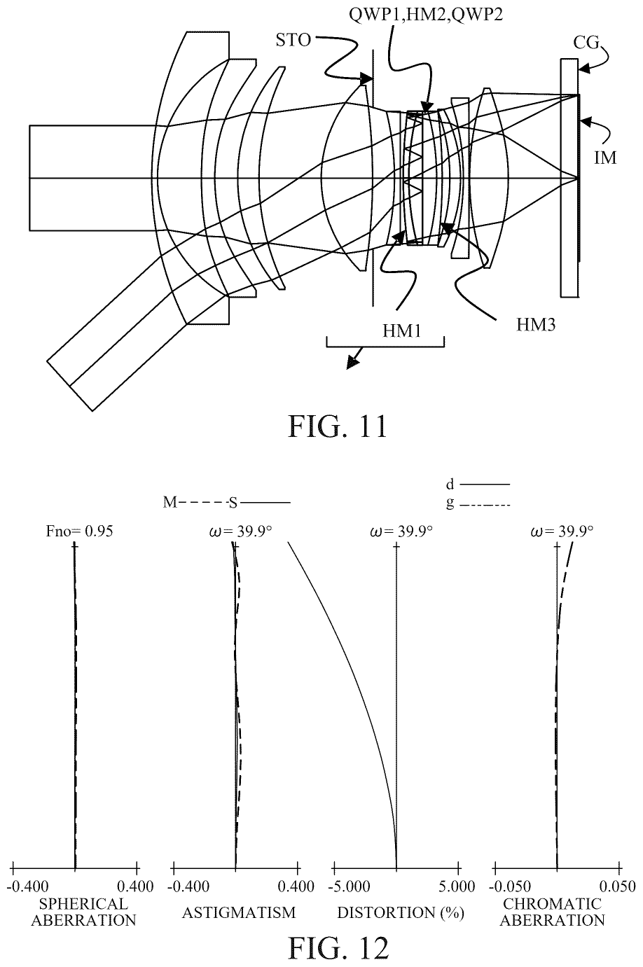

FIGS. 10 and 11 illustrate sections of the first and second optical paths in the optical system according to numerical example 3, respectively. The basic configuration of the optical system according to this example is similar to that of Example 1.

In this example, the first transmissive reflective surface HM1 is provided on a convex surface on the object side of a lens disposed on the image side of the aperture stop STO, and the third transmissive reflective surface HM3 is provided on a concave surface on the object side of a lens closer to the image plane. The first waveplate QWP1, the second transmissive reflective surface HM2, and the second waveplate QWP2 are provided on the flat surface on the image side of a lens cemented to the lens on which the first transmissive reflective surface HM1 is provided.

The optical system according to numerical example 3 has an aperture ratio of about 0.95 and a half angle of view of about 39.86°.

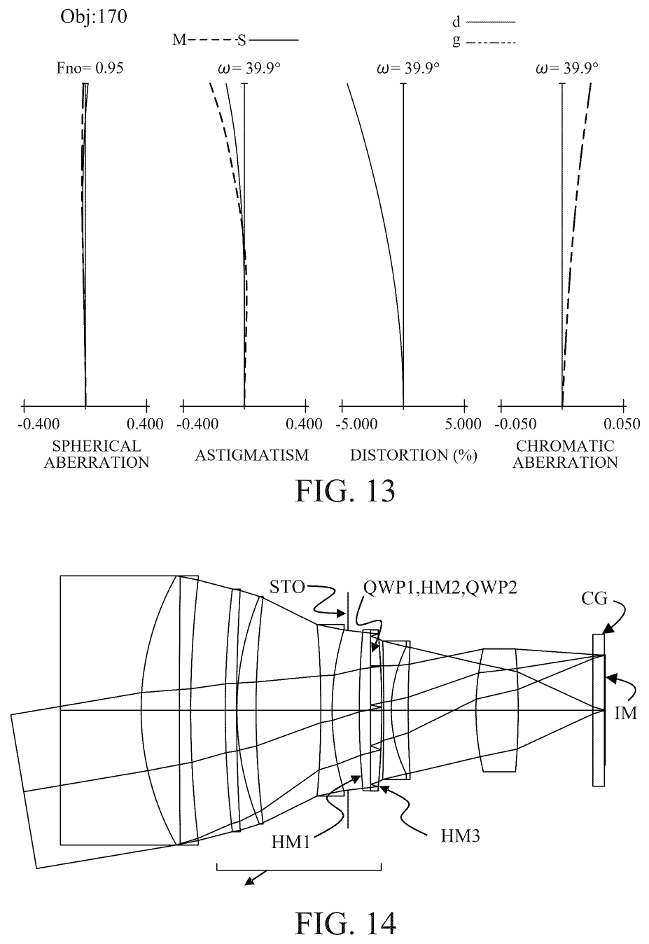

FIGS. 12 and 13 illustrate longitudinal aberrations of the optical system according to numerical example 3 in an in-focus state at infinity and in an in-focus state at a close distance, respectively.

### Example 4

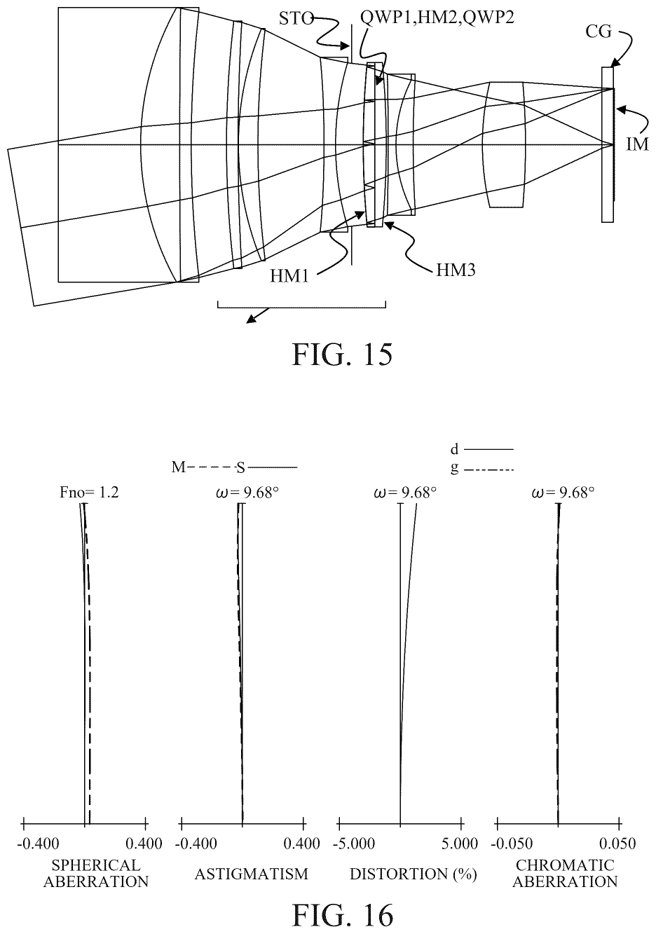

FIGS. 14 and 15 illustrate sections of the first and second optical paths in the optical system according to Example 4 (numerical example 4), respectively. The basic configuration of the optical system of this example is similar to that of Example 1.

In this example, the first transmissive reflective surface HM1 is provided on a convex surface on the object side of a lens disposed on the image side of the aperture stop STO, and the third transmissive reflective surface HM3 is provided as a surface having a concave shape toward the object side on a convex surface on the image side of a lens cemented to and disposed on the image side of the above lens. The first waveplate QWP1, the second transmissive reflective surface HM2, and the second waveplate QWP2 are provided on a flat surface that serves as the cemented surface of these lenses.

The optical system according to numerical example 4 has an aperture ratio of approximately 1.2 and a half angle of view of approximately 9.68°.

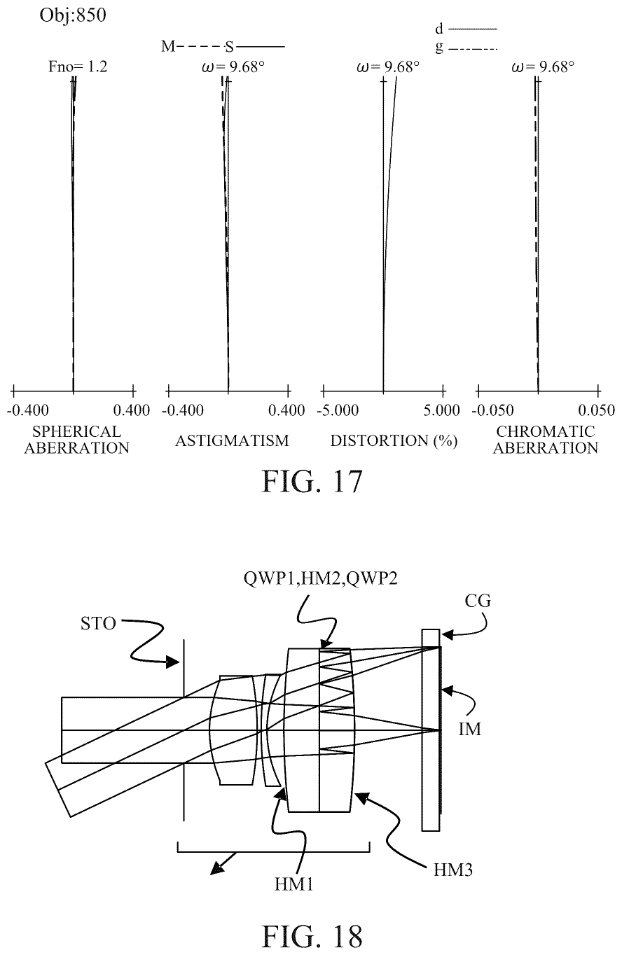

FIGS. 16 and 17 illustrate longitudinal aberrations of the optical system according to numerical example 4 in an in-focus state at infinity and in an in-focus state at a close distance, respectively.

### Example 5

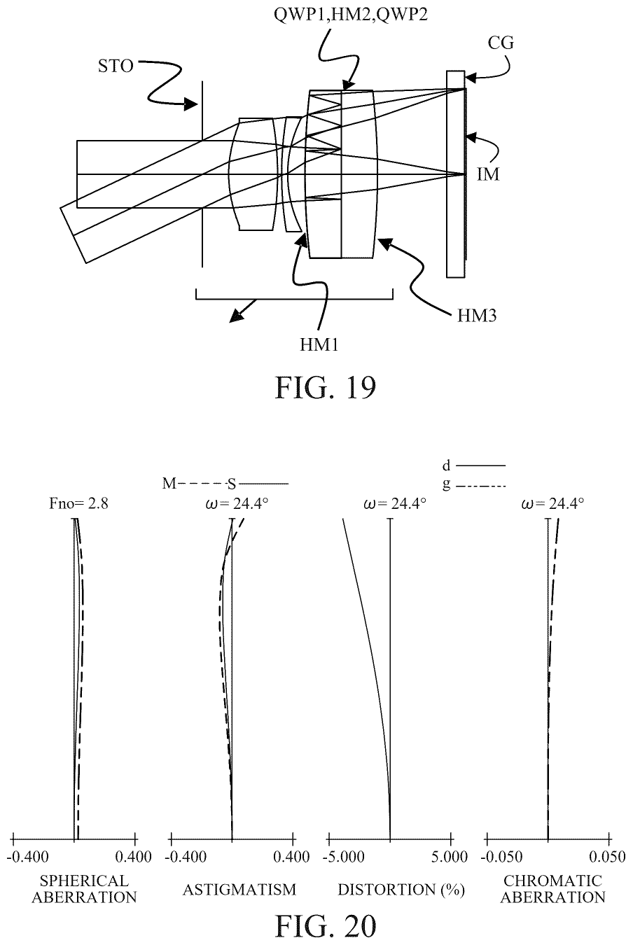

FIGS. 18 and 19 illustrate sections of the first and second optical paths in the optical system according to Example 5 (numerical example 5), respectively. The basic configuration of the optical system according to this example is similar to that of Example 1.

In this example, the first transmissive reflective surface HM1 is provided on a convex surface on the object side of a lens disposed on the image side of the aperture stop STO, and the third transmissive reflective surface HM3 is provided as a surface having a concave shape toward the object side on a convex surface on the image side of a lens cemented to and disposed on the image side of the above lens. The first waveplate QWP1, the second transmissive reflective surface HM2, and the second waveplate QWP2 are provided on a flat surface that serves as the cemented surface of these lenses.

The optical system according to numerical example 5 is an optical system with an aperture ratio of about 2.8 and a half angle of view of about 24.38°.

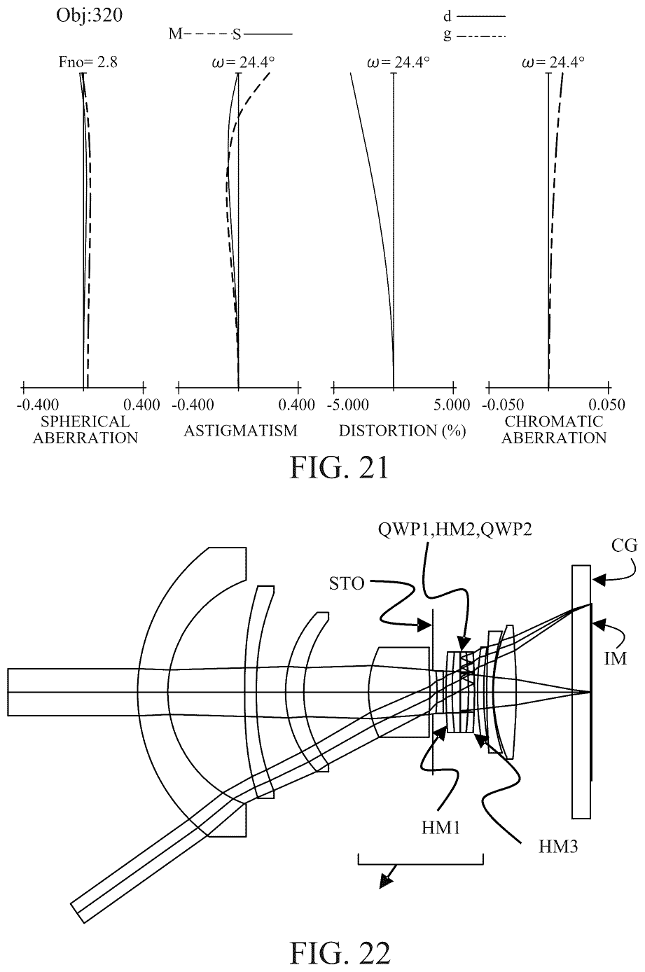

FIGS. 20 and 21 illustrate longitudinal aberrations of the optical system according to numerical example 5 in an in-focus state at infinity and in an in-focus state at a close distance, respectively.

### Example 6

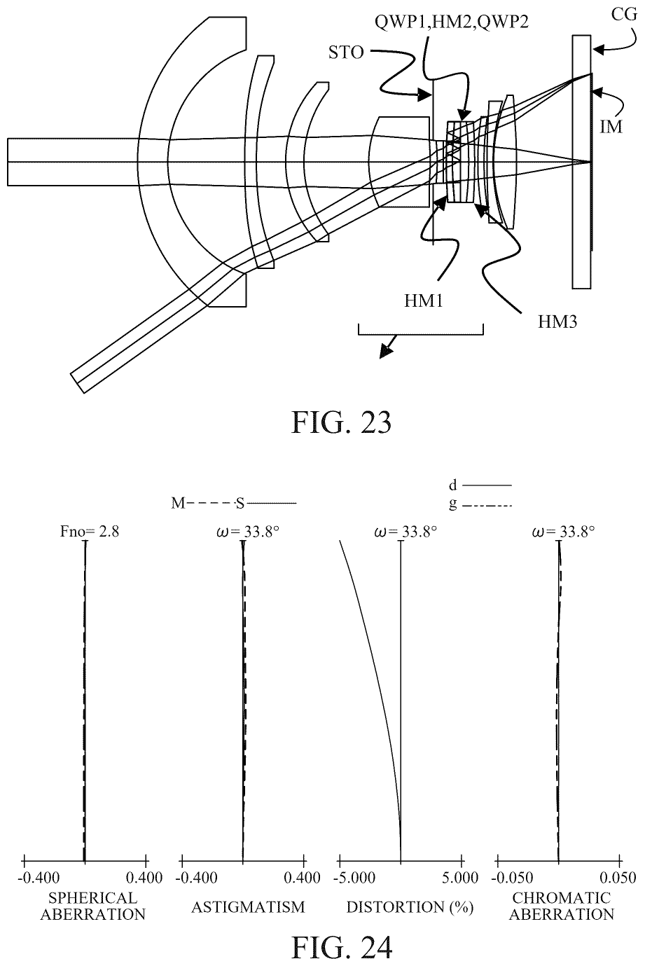

FIGS. 22 and 23 illustrate sections of the first and second optical paths in the optical system according to Example 6 (numerical example 6), respectively. The basic configuration of the optical system of this example is similar to that of Example 1.

In this example, the first transmissive reflective surface HMI is provided on a convex surface on the object side of a lens disposed on the image side of the aperture stop STO, and the third transmissive reflective surface HM3 is provided as a concave surface toward the object side, on a convex surface on the image side of the lens closer to the image plane. The first waveplate QWP1, the second transmissive reflective surface HM2, and the second waveplate QWP2 are provided on the flat surface on the image side of the lens on which the first transmissive reflective surface HM1 is provided.

The optical system according to numerical example 6 is an optical system with an aperture ratio of about 2.8 and a half angle of view of about 33.82°.

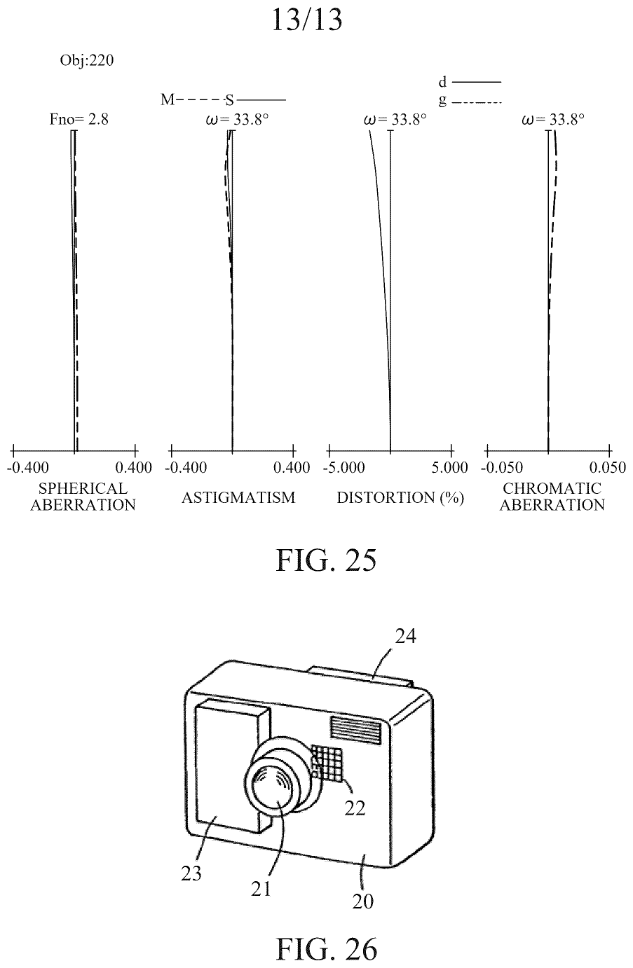

FIGS. 24 and 25 illustrate longitudinal aberrations of the optical system of Numerical Example 6 in an in-focus state at infinity and in an in-focus state at a close distance, respectively.

Next follows various values in the first optical path according to numerical examples 1 to 6. In surface data according to each numerical example, a surface number i represents the order of the surface counted from the object side. r represents a radius of curvature of an i-th surface (mm), d represents a lens thickness or air gap between i-th and (i+1)-th surfaces (mm), and nd represents a refractive index of a material of an i-th optical element for the d-line. vd represents an Abbe number based on the d-line of a material of an i-th optical element. The Abbe number vd based on the d-line is expressed as:

$$vd = ( Nd - 1 ) / ( NF - NC )$$

where Nd, NF, and NC are refractive indices in the Fraunhofer lines for the d-line (587.6 nm), F-line (486.1 nm), and C-line (656.3 nm), respectively.

In each numerical example, d, focal length (mm), Fno, and half angle of view (°) are all values when the optical system is in an in-focus state at infinity. BF represents the back focus (mm). Back focus is a distance on the optical axis from the surface closest to the image plane of the optical system (final surface) to the paraxial image plane, expressed as the air-equivalent length.

An asterisk “*” next to a surface number means that the surface has an aspherical shape. The aspherical shape is expressed by the following equation:

$$x = ( {h}^{2} / R ) / [ 1 + √ \{ 1 - ( 1 + K ) {( h / R )}^{2} \} ] + A 4 \times {h}^{4} + A 6 \times {h}^{6} + A 8 \times {h}^{8} + A 10 \times {h}^{10}$$

where x is a displacement amount in the optical axis direction from a surface vertex at a height h from the optical axis, R is a paraxial radius of curvature, K is a conic constant, and Ai (i=2, 4, 6, 8, . . . ) are aspherical coefficients of each order. The “e±M” in the conic constant and aspherical coefficient means×10^{±M}.

Various data illustrate a focal length (mm), an F-number, a half angle of view (°), and an image height (mm).

NUMERICAL EXAMPLE 1
UNIT: mm
SURFACE DATA

| Surface No. | r | d | nd | νd |
|---|---|---|---|---|
| 1* | −94.107 | 1.80 | 1.58913 | 61.1 |
| 2* | 76.271 | 0.20 | | |
| 3 | 52.548 | 3.30 | 1.80518 | 25.4 |
| 4 | 210.007 | 1.16 | | |
| 5 | −488.286 | 1.50 | 2.00100 | 29.1 |
| 6 | 58.168 | 6.84 | 1.75500 | 52.3 |
| 7 | −55.281 | 0.50 | | |
| 8 (SP) | ∞ | 14.75 | | |
| 9 | 102.432 | 2.32 | 1.78470 | 26.3 |
| 10 | ∞ | 2.32 | 1.78470 | 26.3 |
| 11 | −102.432 | −2.32 | | |
| 12 | ∞ | 2.32 | | |
| 13 | −102.432 | 1.70 | 2.00100 | 29.1 |
| 14* | 30.774 | 5.13 | | |
| 15 | −40.943 | 1.62 | 2.00100 | 29.1 |
| 16 | −38.906 | 1.00 | | |
| 17 | 48.199 | 8.07 | 1.49700 | 81.5 |
| 18 | −26.326 | 2.04 | 1.83481 | 42.7 |
| 19 | −910.871 | 0.10 | | |
| 20* | 53.194 | 8.67 | 1.59522 | 67.7 |
| 21* | −36.271 | 9.40 | | |
| 22 | ∞ | 3.00 | 1.51633 | 64.1 |
| 23 | ∞ | 0.10 | | |
| Image Plane | ∞ | | | |

ASPHERIC DATA
1st Surface
K = 0.00000e+00 A 4 = −2.01384e−06 A 6 = 1.05466e−09
2nd Surface
K = 0.00000e+00 A 4 = 1.45010e−06 A 6 = 1.70305e−09
14th Surface
K = 0.00000e+00 A 4 = −6.41282e−07 A 6 = −2.57751e−09
A 8 = 7.90939e−12 A10 = −2.56976e−14
20th Surface
K = 0.00000e+00 A 4 = −4.70322e−07 A 6 = 4.45271e−09
21st Surface
K = 0.00000e+00 A 4 = 7.89133e−06 A 6 = −9.88331e−09
A 8 = 3.68077e−11 A10 = −3.74355e−14

VARIOUS DATA

| | |
|---|---|
| Focal Length | 32.00 |
| Fno | 0.95 |
| Half Angle of View (°) | 24.38 |
| Image Height | 14.50 |
| BF | 0.10 |

NUMERICAL EXAMPLE 2
UNIT: mm
SURFACE DATA

| Surface No. | r | d | nd | νd |
|---|---|---|---|---|
| 1* | −285.181 | 1.80 | 1.51742 | 52.4 |
| 2* | 55.862 | 0.20 | | |
| 3 | 53.636 | 8.52 | 1.80400 | 46.6 |
| 4 | 497.664 | 4.93 | | |
| 5 | 907.970 | 1.50 | 1.80400 | 46.6 |
| 6 | 78.163 | 10.20 | 1.60300 | 65.4 |
| 7 | −103.443 | 0.50 | | |
| 8 (SP) | ∞ | 19.94 | | |
| 9 | 153.852 | 3.92 | 1.80518 | 25.4 |
| 10 | ∞ | 3.92 | 1.80518 | 25.4 |
| 11 | −153.852 | −3.92 | | |
| 12 | ∞ | 3.92 | | |
| 13 | −153.852 | 1.70 | 2.00330 | 28.3 |
| 14* | 40.984 | 6.88 | | |
| 15 | −57.350 | 1.65 | 1.80518 | 25.4 |
| 16 | −54.518 | 1.00 | | |
| 17 | 669.365 | 6.47 | 1.59522 | 67.7 |
| 18 | −31.952 | 2.40 | 1.88300 | 40.8 |
| 19 | −278.234 | 2.85 | | |
| 20* | 54.403 | 10.66 | 1.51823 | 58.9 |
| 21* | −43.863 | 15.47 | | |
| 22 | ∞ | 3.00 | 1.51633 | 64.1 |
| 23 | ∞ | 0.10 | | |
| Image Plane | ∞ | | | |

ASPHERIC DATA
1st Surface
K = 0.00000e+00 A 4 = −5.42118e−07 A 6 = −2.96568e−11
2nd Surface
K = 0.00000e+00 A 4 = 4.58806e−07 A 6 = 1.21547e−10
14th Surface
K = 0.00000e+00 A 4 = 1.28694e−07 A 6 = −1.93586e−10
A 8 = 8.69864e−13 A10 = −6.61327e−16
20th Surface
K = 0.00000e+00 A 4 = −1.08573e−06 A 6 = −7.72692e−10
21st Surface
K = 0.00000e+00 A 4 = 3.94929e−06 A 6 = −4.67606e−09
A 8 = 8.04931e−12 A10 = −6.11647e−15

VARIOUS DATA

| | |
|---|---|
| Focal Length | 53.13 |
| Fno | 0.95 |
| Half Angle of View (°) | 15.27 |
| Image Height | 14.50 |
| BF | 0.10 |

NUMERICAL EXAMPLE 3
UNIT: mm
SURFACE DATA

| Surface No. | r | d | nd | νd |
|---|---|---|---|---|
| 1 | 55.751 | 1.00 | 1.62041 | 60.3 |
| 2 | 23.340 | 7.70 | | |
| 3* | 70.604 | 2.35 | 1.51633 | 64.1 |
| 4* | 34.019 | 3.99 | | |
| 5 | 29.326 | 3.75 | 1.80518 | 25.4 |
| 6 | 41.944 | 10.93 | | |
| 7 | 22.456 | 8.98 | 1.49700 | 81.5 |
| 8 | −104.157 | 0.10 | | |
| 9 (SP) | ∞ | 3.76 | | |
| 10 | −47.717 | 1.00 | 1.72916 | 54.7 |
| 11 | 9405.818 | 0.50 | | |
| 12* | 83.368 | 1.00 | 1.88300 | 40.8 |
| 13* | 46.532 | 2.43 | 1.51633 | 64.1 |
| 14 | ∞ | 2.43 | 1.51633 | 64.1 |
| 15* | −46.532 | 1.00 | 1.88300 | 40.8 |
| 16* | −83.368 | −1.00 | | |
| 17* | −46.532 | −2.43 | 1.51633 | 64.1 |
| 18 | ∞ | 2.43 | | |
| 19* | −46.532 | 1.00 | 1.88300 | 40.8 |
| 20* | −83.368 | 1.34 | | |
| 21 | −33.281 | 1.85 | 1.51633 | 64.1 |
| 22 | −25.687 | 0.50 | | |
| 23 | −42.255 | 1.00 | 1.95375 | 32.3 |
| 24 | −1992.251 | 0.10 | | |
| 25* | 45.697 | 6.78 | 1.77250 | 49.6 |
| 26* | −32.935 | 9.40 | | |
| 27 | ∞ | 3.00 | 1.51633 | 64.1 |
| 28 | ∞ | 0.10 | | |
| Image Plane | ∞ | | | |

ASPHERIC DATA
3rd Surface
K = 0.00000e+00 A 4 = 2.41089e−05 A 6 = −4.66339e−08
A 8 = 3.98433e−11 A10 = −2.36767e−14
4th Surface
K = 0.00000e+00 A 4 = 2.56034e−05 A 6 = −4.76636e−08
12th Surface
K = 0.00000e+00 A 4 = −2.07388e−06 A 6 = −3.24551e−09
A 8 = −1.93377e−11
13th Surface
K = 0.00000e+00 A 4 = 2.69899e−06 A 6 = 8.95419e−09
A 8 = −5.45146e−11
15th Surface
K = 0.00000e+00 A 4 = −2.69899e−06 A 6 = −8.95419e−09
A 8 = 5.45146e−11
16th Surface
K = 0.00000e+00 A 4 = 2.07388e−06 A 6 = 3.24551e−09
A 8 = 1.93377e−11
17th Surface
K = 0.00000e+00 A 4 = −2.69899e−06 A 6 = −8.95419e−09
A 8 = 5.45146e−11
19th Surface
K = 0.00000e+00 A 4 = −2.69899e−06 A 6 = −8.95419e−09
A 8 = 5.45146e−11
20th Surface
K = 0.00000e+00 A 4 = 2.07388e−06 A 6 = 3.24551e−09
A 8 = 1.93377e−11
25th Surface
K = 0.00000e+00 A 4 = −8.43406e−06 A 6 = 2.76741e−08
A 8 = −2.77767e−11
26th Surface
K = 0.00000e+00 A 4 = 1.09800e−05 A 6 = −9.64897e−09
A 8 = −9.45847e−11 A10 = −1.75246e−13

VARIOUS DATA

| | |
|---|---|
| Focal Length | 17.37 |
| Fno | 0.95 |
| Half Angle of View (°) | 39.86 |
| Image Height | 14.50 |
| BF | 0.10 |

NUMERICAL EXAMPLE 4
UNIT: mm
SURFACE DATA

| Surface No. | r | d | nd | νd |
|---|---|---|---|---|
| 1 | 71.616 | 10.13 | 1.60300 | 65.4 |
| 2 | 2625.506 | 3.00 | 1.65412 | 39.7 |
| 3 | 294.518 | 9.18 | | |
| 4 | 269.737 | 3.00 | 2.00100 | 29.1 |
| 5 | 499.753 | 0.10 | | |
| 6 | 78.041 | 5.07 | 1.53775 | 74.7 |
| 7 | 237.310 | 17.17 | | |
| 8* | −312.370 | 3.00 | 1.80400 | 46.6 |
| 9 | 72.936 | 4.20 | | |
| 10 (SP) | ∞ | 3.00 | | |
| 11 | 219.573 | 3.00 | 1.51633 | 64.1 |
| 12 | ∞ | 3.00 | 1.51633 | 64.1 |
| 13 | −219.573 | −3.00 | | |
| 14 | ∞ | 3.00 | | |
| 15 | −219.573 | 0.50 | | |
| 16 | −698.013 | 2.00 | 1.95375 | 32.3 |
| 17 | 37.027 | 4.48 | 1.51633 | 64.1 |
| 18 | 277.750 | 17.98 | | |
| 19 | 68.324 | 11.20 | 1.80518 | 25.4 |
| 20 | −184.668 | 20.00 | | |
| 21 | ∞ | 3.00 | 1.51633 | 64.1 |
| 22 | ∞ | 0.10 | | |
| Image Plane | ∞ | | | |

ASPHERIC DATA
8th Surface
K = 0.00000e+00 A 4 = −7.54205e−07 A 6 = 1.65340e−10
A 8 = −7.14643e−15

VARIOUS DATA

| | |
|---|---|
| Focal Length | 85.00 |
| Fno | 1.20 |
| Half Angle of View (°) | 9.68 |
| Image Height | 14.50 |
| BF | 0.10 |

NUMERICAL EXAMPLE 5
UNIT: mm
SURFACE DATA

| Surface No. | r | d | nd | νd |
|---|---|---|---|---|
| 1 (SP) | ∞ | 4.50 | | |
| 2* | 20.430 | 8.34 | 1.51742 | 52.4 |
| 3 | −52.701 | 0.69 | | |
| 4 | 58.909 | 1.00 | 1.91650 | 31.6 |
| 5* | 19.763 | 2.98 | | |
| 6 | 119.924 | 6.20 | 1.49700 | 81.5 |
| 7 | ∞ | 6.20 | 1.49700 | 81.5 |
| 8 | −119.924 | −6.20 | | |
| 9 | ∞ | 6.20 | | |
| 10 | −119.924 | 12.00 | | |
| 11 | ∞ | 3.00 | 1.51633 | 64.1 |
| 12 | ∞ | 0.10 | | |
| Image Plane | ∞ | | | |

ASPHERIC DATA
2nd Surface
K = 0.00000e+00 A 4 = −2.65515e−05 A 6 = −2.97402e−08
A 8 = 2.10475e−10
5th Surface
K = 0.00000e+00 A 4 = −8.08934e−06 A 6 = −4.80167e−08
A 8 = 1.20263e−10

VARIOUS DATA

| | |
|---|---|
| Focal Length | 32.00 |
| Fno | 2.80 |
| Half Angle of View (°) | 24.38 |
| Image Height | 14.50 |
| BF | 0.10 |

NUMERICAL EXAMPLE 6
UNIT: mm
SURFACE DATA

| Surface No. | r | d | nd | νd |
|---|---|---|---|---|
| 1 | 29.653 | 5.00 | 1.43875 | 94.9 |
| 2 | 19.530 | 12.69 | | |
| 3* | 152.941 | 1.91 | 1.43875 | 94.9 |
| 4* | 67.284 | 4.83 | | |
| 5 | 18.891 | 3.02 | 1.67270 | 32.1 |
| 6 | 19.241 | 10.70 | | |
| 7 | 16.685 | 10.11 | 1.53775 | 74.7 |
| 8 | −61.074 | 0.50 | | |
| 9 (SP) | ∞ | 0.69 | | |
| 10 | −32.800 | 1.00 | 1.89190 | 37.1 |
| 11 | 301.503 | 0.50 | | |
| 12* | 87.959 | 1.00 | 1.72916 | 54.7 |
| 13* | 56.015 | 1.34 | 1.43875 | 94.9 |
| 14 | ∞ | 1.34 | 1.43875 | 94.9 |
| 15* | −56.015 | 1.00 | 1.72916 | 54.7 |
| 16* | −87.959 | −1.00 | | |
| 17* | −56.015 | −1.34 | 1.43875 | 94.9 |
| 18 | ∞ | 1.34 | | |
| 19* | −56.015 | 1.00 | 1.72916 | 54.7 |
| 20* | −87.959 | 0.50 | | |
| 21 | 46.022 | 1.03 | 1.84666 | 23.8 |
| 22 | 51.041 | 0.50 | | |
| 23 | 135.106 | 1.00 | 1.80400 | 46.6 |
| 24 | 32.485 | 0.10 | | |
| 25* | 26.095 | 3.75 | 1.56732 | 42.8 |
| 26* | −86.901 | 9.40 | | |
| 27 | ∞ | 3.00 | 1.51633 | 64.1 |
| 28 | ∞ | 0.10 | | |
| Image Plane | ∞ | | | |

ASPHERIC DATA
3rd Surface
K = 0.00000e+00 A 4 = 2.41089e−05 A 6 = −4.66339e−08
A 8 = 3.98433e−11 A10 = −2.36767e−14
4th Surface
K = 0.00000e+00 A 4 = 2.56034e−05 A 6 = −4.76636e−08
12th Surface
K = 0.00000e+00 A 4 = −1.57730e−06 A 6 = 9.96129e−08
A 8 = −6.61859e−09
13th Surface
K = 0.00000e+00 A 4 = 1.51977e−05 A 6 = 4.44825e−07
A 8 = −2.73136e−08
15th Surface
K = 0.00000e+00 A 4 = −1.51977e−05 A 6 = −4.44825e−07
A 8 = 2.73136e−08
16th Surface
K = 0.00000e+00 A 4 = 1.57730e−06 A 6 = −9.96129e−08
A 8 = 6.61859e−09
17th Surface
K = 0.00000e+00 A 4 = −1.51977e−05 A 6 = −4.44825e−07
A 8 = 2.73136e−08
19th Surface
K = 0.00000e+00 A 4 = −1.51977e−05 A 6 = −4.44825e−07
A 8 = 2.73136e−08
20th Surface
K = 0.00000e+00 A 4 = 1.57730e−06 A 6 = −9.96129e−08
A 8 = 6.61859e−09
25th Surface
K = 0.00000e+00 A 4 = −8.43406e−06 A 6 = 2.76741e−08
A 8 = −2.77767e−11
26th Surface
K = 0.00000e+00 A 4 = 1.09800e−05 A 6 = −9.64897e−09
A 8 = 9.45847e−11 A10 = −1.75246e−13

VARIOUS DATA

| | |
|---|---|
| Focal Length | 21.65 |
| Fno | 2.80 |
| Half Angle of View (°) | 33.82 |
| Image Height | 14.50 |
| BF | 0.10 |

Table 1 summarizes values of inequalities (1) to (8) in each numerical example.

TABLE 1

Numerical Example

| | 1 | 2 | 3 | 4 | 5 | 6 |
|---|---|---|---|---|---|---|
| L1s/L | 0.20 | 0.26 | 0.52 | 0.45 | −0.10 | 0.65 |
| Nd | 1.78 | 1.81 | 1.52 | 1.52 | 1.50 | 1.44 |
| zm3/f | 1.28 | 0.98 | 1.39 | 0.70 | 0.47 | 0.90 |
| Dm12/L | 0.03 | 0.04 | 0.05 | 0.02 | 0.14 | 0.03 |
| f1s/f | 5.66 | 2.96 | 2.61 | 3.02 | — | 1.27 |
| Φ3/Φ | 1.12 | 1.25 | 1.41 | 1.17 | 0.80 | 1.34 |
| L/f | 2.36 | 2.03 | 4.32 | 1.45 | 1.41 | 3.46 |
| Fno | 0.95 | 0.95 | 0.95 | 1.20 | 2.80 | 2.80 |

### Image Pickup Apparatus

FIG. 26 illustrates a digital still camera as an image pickup apparatus having the optical system according to any one of the above examples. Reference numeral 20 denotes a camera body, and reference numeral 21 denotes an imaging optical system according to any one of Examples 1 to 6. Reference numeral 22 denotes a solid-state image sensor such as a CCD sensor or CMOS sensor that is built into the camera body 20 and photoelectrically converts an optical image (object image) formed by the imaging optical system 21, i.e., captures the object image through the imaging optical system 21. Reference numeral 23 denotes a recorder that records image data generated by processing an imaging signal from the image sensor 22, and reference numeral 24 denotes a rear display that displays the image data.

Utilizing the optical system according to each example can provide a camera with a reduced size and high optical performance.

The camera may be a single-lens reflex camera with a quick-turn mirror, or a mirrorless camera without a quick-turn mirror.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an imaging optical system having a reduced size, a bright F-number, and high transmittance.

This application claims priority to Japanese Patent Application No. 2024-113273, which was filed on Jul. 16, 2024, and which is hereby incorporated by reference herein in its entirety.

What is claimed is:

1. An optical system comprising:
a first lens disposed closest to an object;
a first transmissive reflective surface, a first waveplate, a second transmissive reflective surface, a second waveplate, and a third transmissive reflective surface arranged in this order from an object side to an image side; and
an aperture stop,
wherein the following inequality is satisfied:
$$- 0.2 < L 1 s / L < 0.95$$
where L is a distance on an optical axis from a surface on the object side of the first lens to the image plane, and L1s is a distance on the optical axis from the surface on the object side of the first lens to the aperture stop.

2. The optical system according to claim 1, wherein in a first optical path, the light incident from the object side transmits through the first transmissive reflective surface, transmits through the first waveplate, transmits through the second transmissive reflective surface, transmits through the second waveplate, is reflected by the third transmissive reflective surface, transmits through the second waveplate, is reflected by the second transmissive reflective surface, transmits through the second waveplate, transmits through the third transmissive reflective surface, and reaches the image plane, and
wherein in a second optical path, the light transmits through the first transmissive reflective surface, transmits through the first waveplate, is reflected by the second transmissive reflective surface, transmits through the first waveplate, is reflected by the first transmissive reflective surface, transmits through the first waveplate, transmits through the second transmissive reflective surface, transmits through the second waveplate, transmits through the third transmissive reflective surface, and reaches the image plane.

3. The optical system according to claim 1, wherein the following inequality is satisfied:
$$1.05 < Nd < 2.5$$
where Nd is a minimum refractive index for d-line of a medium between the first transmissive reflective surface and the second transmissive reflective surface and a medium between the second transmissive reflective surface and the third transmissive reflective surface.

4. The optical system according to claim 1, wherein the following inequality is satisfied:
$$0.2 < Zm 3 / f < 2.$$
where Zm3 is a distance on the optical axis from the third transmissive reflective surface to the image plane, and f is a focal length of the optical system.

5. The optical system according to claim 1, wherein the following inequality is satisfied:
$$0.01 < Dm 12 / L < 0.2$$
where Dm12 is a distance on the optical axis between the first transmissive reflective surface and the second transmissive reflective surface.

6. The optical system according to claim 1, wherein the following inequality is satisfied:
$$0.5 < f 1 s / f < 7.$$
where f1s is a combined focal length of at least one lens disposed on the object side of the aperture stop, and f is a focal length of the optical system.

7. The optical system according to claim 1, wherein the following inequality is satisfied:
$$0.5 < Φ 3 / Φ < 2.$$
where Φ3 is optical power for light reflected by the third transmissive reflective surface and expressed as Φ3=−2×Nd3/R, Φ is optical power of the optical system, Nd3 is a refractive index for d-line of a medium disposed on the object side of and adjacent to the third transmissive reflective surface, and R is a radius of curvature of the third transmissive reflective surface.

8. The optical system according to claim 1, wherein the following inequality is satisfied:
$$1. < L / f < 5.5$$
where f is a focal length of the optical system.

9. The optical system according to claim 1, wherein the following inequality is satisfied:
$$0.55 \leq Fno \leq 8.$$
where Fno is an maximum aperture value of the optical system.

10. The optical system according to claim 1, wherein the second transmissive reflective surface is flat.

11. The optical system according to claim 1, wherein the first transmissive reflective surface is a convex surface toward the object side, and the third transmissive reflective surface is a concave surface toward the object side.

12. The optical system according to claim 1, wherein the following inequality is satisfied:
$$1. < L / f < 5.5$$
where f is a focal length of the optical system.

13. The optical system according to claim 1, wherein each of the first transmissive reflective surface and the third transmissive reflective surface includes a reflective polarizer.

14. The optical system according to claim 1, wherein the second transmissive reflective surface includes a half-mirror.

15. The optical system according to claim 1, wherein the third transmissive reflective surface is disposed on the image side of the aperture stop.

16. An optical system comprising:
a first lens disposed closest to an object;
a first transmissive reflective surface, a first waveplate, a second transmissive reflective surface, a second waveplate, and a third transmissive reflective surface; and
an aperture stop,
wherein light incident from the object side is imaged on an image plane via two optical paths including transmission and reflection at the first transmissive reflective surface, the second transmissive reflective surface, and the third transmissive reflective surface.

17. An image pickup apparatus comprising:
an optical system; and
an image sensor configured to image an object through the optical system,
wherein the optical system includes:
a first lens disposed closest to an object;
a first transmissive reflective surface, a first waveplate, a second transmissive reflective surface, a second waveplate, and a third transmissive reflective surface arranged in this order from an object side to an image side; and
an aperture stop,
wherein the following inequality is satisfied:
$$- 0.2 < L 1 s / L < 0.95$$
where L is a distance on an optical axis from a surface on the object side of the first lens to the image plane, and L1s is a distance on the optical axis from the surface on the object side of the first lens to the aperture stop.

18. An optical system comprising:
a first lens disposed closest to an object;
a first transmissive reflective surface, a first waveplate, a second transmissive reflective surface, a second waveplate, and a third transmissive reflective surface arranged in this order from an object side to an image side; and
an aperture stop,
wherein the first transmissive reflective surface is a convex surface toward the object side, and the third transmissive reflective surface is a concave surface toward the object side, and
wherein the following inequality is satisfied:
$$- 0.2 < L 1 s / L < 0.95$$
where L is a distance on an optical axis from a surface on the object side of the first lens to the image plane, and L1s is a distance on the optical axis from the surface on the object side of the first lens to the aperture stop.
